(19) United States
(12) Patent Application Publication
(10) Pub. No.: US 2026/0115692 A1
(43) Pub. Date: Apr. 30, 2026

(54) CATALYST PARTICLE AND METHOD FOR PRODUCING CATALYST PARTICLE

(71) Applicants: HONDA MOTOR CO.,LTD., Tokyo (JP); Kyoto University, Kyoto (JP)

(72) Inventors: Keisuke FUJITA, Saitama (JP); Yuichi MATSUO, Saitama (JP); Hisao YOSHIDA, Kyoto (JP); Akira YAMAMOTO, Kyoto (JP); Hongxuan QIU, Kyoto (JP)

(21) Appl. No.: 19/353,616

(22) Filed: Oct. 9, 2025

(30) Foreign Application Priority Data
Oct. 30, 2024 (JP) 2024-190666

(51) Int. Cl. B01J 21/06; B01J 23/883; B01J 35/39; B01J 35/70; B01J 37/02; C01B 3/04

(52) U.S. Cl. CPC B01J 21/063; B01J 23/883; B01J 35/39; B01J 35/733; B01J 37/0201; C01B 3/042

(57) ABSTRACT

A highly active catalyst particle includes a photocatalyst 2 and a cocatalyst 3 supported on the photocatalyst 2, in which the cocatalyst 3 contains a first cocatalyst 31 and a second cocatalyst 32, the first cocatalyst 31 contains at least one of Group 3 to Group 7 elements, the second cocatalyst 32 contains at least one of Group 8 to Group 11 elements, and the photocatalyst 2 contains titanium at 16 at % or more, and decomposes water under light irradiation to generate hydrogen and oxygen.

The contents of the following patent application(s) are incorporated herein by reference: NO. 2024-190666 filed in JP on Oct. 30, 2024.

### BACKGROUND

### 1. Technical Field

The present invention relates to a catalyst particle which decomposes water molecules upon irradiation with light to generate hydrogen and oxygen, and a method for producing such a catalyst particle.

### 2. Related Art

Patent Document 1 discloses a photocatalyst laminate having a photocatalyst particle layer in which a plurality of photocatalyst particles for hydrogen generation and a plurality of photocatalyst particles for oxygen generation exist in a mutually dispersed state. However, in this method, it was necessary to synthesize a plurality of different photocatalysts and disperse them. Further, even though a plurality of photocatalysts were used, they were dispersed and did not function concertedly.

### RELATED ART DOCUMENTS

### Patent Documents

Patent Document 1: Japanese Patent Application Publication No. 2016-059920

### BRIEF DESCRIPTION OF THE DRAWINGS

FIG. 1 illustrates an outline of a configuration of a catalyst particle.

FIG. 2A schematically illustrates distributions on a photocatalyst 2 of a first cocatalyst and a second cocatalyst.

FIG. 2B illustrates distributions on a photocatalyst of the first cocatalyst and the second cocatalyst supported by an SPD method.

FIG. 2C illustrates distribution on a photocatalyst of the first cocatalyst and the second cocatalyst supported by a PD method.

FIG. 3 illustrates a method for producing a catalyst particle by supporting a cocatalyst on a photocatalyst by the SPD method.

FIG. 4 illustrates results of water decomposition tests using a catalyst particle in which molybdenum and nickel were supported on calcium titanium oxide (CTO), a catalyst particle consisting of CTO alone, a catalyst particle consisting of nickel oxide alone, a catalyst particle consisting of molybdenum oxide alone, and a catalyst particle in which nickel oxide and molybdenum oxide were simply mixed with CTO.

FIG. 5 illustrates results of water decomposition tests using a catalyst particle in which two types of cocatalysts were supported on a photocatalyst by the SPD method and a catalyst particle in which a noble metal was supported as a cocatalyst on a photocatalyst.

FIG. 6 illustrates results of water decomposition tests using a catalyst particle using nickel nitrate alone as a cocatalyst material, a catalyst particle using sodium molybdate alone as a cocatalyst material, and a catalyst particle using nickel nitrate and sodium molybdate as cocatalysts.

FIG. 7 illustrates results of water decomposition tests using different catalyst particles in a method of supporting the first cocatalyst and the second cocatalyst on a photocatalyst.

FIG. 8 illustrates results of water decomposition tests using a catalyst particle in which a loading amount of the first cocatalyst was varied.

FIG. 9 illustrates results of water decomposition tests using a catalyst particle in which a loading amount of a second cocatalyst was varied.

FIG. 10 illustrates results of water decomposition tests using a catalyst particle in which a composition ratio of the first cocatalyst and the second cocatalyst was varied.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to a solution of the invention.

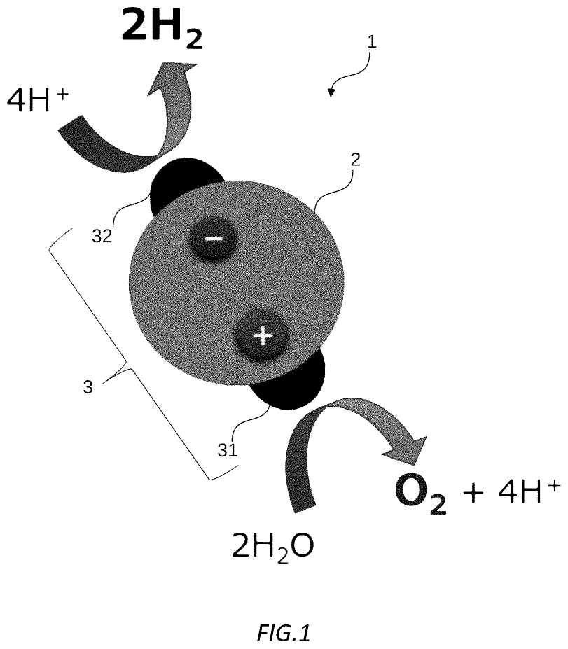

FIG. 1 illustrates an outline of a configuration of a catalyst particle. A catalyst particle 1 includes a photocatalyst 2 and a cocatalyst 3 supported on the photocatalyst 2, and decomposes water molecules upon irradiation with light to generate hydrogen and oxygen.

The photocatalyst 2 is a particle in which, when irradiated with light, electrons in a valence band are excited (photoexcited) by energy of the light, the electrons transition from the valence band to a conduction band, holes are generated in the valence band after the electrons transition, and water molecules are decomposed by redox reaction to generate hydrogen (hydrogen molecules) and oxygen (oxygen molecules). The particle of the photocatalyst 2 is a polyhedron reflecting a crystal structure of a substance contained in the particle, and has an oxidation surface and a reduction surface. The oxidation surface is a facet which promotes oxidation reaction. The reduction surface is a facet which promotes reduction reaction. The photocatalyst 2 preferably contains a substance having a titanium content of 16 at % or more, more preferably contains a substance having a titanium content of 18 at % or more, and still more preferably contains a substance having a titanium content of 20 at % or more. Examples of such a substance include titanium dioxide (TiO₂), titanium oxyfluoride (TiOF₂), barium titanium oxide (BaTiO₃), calcium titanium oxide (CaTiO₃), strontium titanium oxide (SrTiO₃), potassium titanium oxide (K₂TiₙO₂ₙ₊₁), sodium titanium oxide (Na₂TiₙO₂ₙ₊₁), lead titanium oxide (PbTiO₃), lanthanum titanium oxide (La₂Ti₂O₇), and the like. Use of a substance containing 16 at % or more of titanium, which is known to be chemically stable, for the photocatalyst 2 can achieve high durability against corrosion and aging.

The photocatalyst 2 more preferably contains a titanate such as barium titanium oxide (BaTiO₃), calcium titanium oxide (CaTiO₃), strontium titanium oxide (SrTiO₃), potassium titanium oxide (K₂TiO₃), sodium titanium oxide (Na₂TiO₃), lead titanium oxide (PbTiO₃), or lanthanum titanium oxide (La₂Ti₂O₇), among substances containing 16 at % or more of titanium.

The photocatalyst 2 more preferably contains a substance having a perovskite-type crystal structure, such as barium titanium oxide (BaTiO₃), calcium titanium oxide (CaTiO₃), strontium titanium oxide (SrTiO₃), or lead titanium oxide (PbTiO₃), among substances containing 16 at % or more of titanium. The perovskite-type crystal structure is represented by a general formula ABX₃, where A, B, and X are regularly arranged, and thus has few crystal defects and tends to have a larger band gap than a photocatalyst such as titanium dioxide. A represents a cation such as calcium (Ca), strontium (Sr), or barium (Ba), B represents a cation smaller than A, such as titanium (Ti), manganese (Mn), or iron (Fe), and X represents an anion such as oxygen (O), fluorine (F), or chlorine (CI). By using photocatalyst 2 having a perovskite-type crystal structure having few crystal defects and an appropriate band gap, carrier recombination can be suppressed to promote the redox reaction. In addition, heat resistance and durability can be improved.

Note that in the photocatalyst 2, the valence band is an allowable band (band) completely filled with electrons at absolute zero. The conduction band is a band which exists across a forbidden band (band gap) from the valence band. When irradiated with light having energy corresponding to or higher than band gap energy, electrons in the valence band are excited to transition to the conduction band, and holes are generated in the valence band after the electrons transition. Accordingly, electron-hole pairs are generated.

When expressed in terms of the standard hydrogen electrode potential, an energy level at a valence band maximum of the photocatalyst 2 is higher than +1.23 V, which is a generation potential (oxidation potential) of oxygen, and an energy level at a conduction band minimum is lower than 0 V, which is a generation potential (reduction potential) of hydrogen. That is, the band gap of the photocatalyst 2 is 1.23 eV or more.

The light to be radiated is selected according to the band gap of the photocatalyst 2. For example, in a case of rutile titanium dioxide, band gap energy is about 3.0 eV (corresponding to a light wavelength of about 414 nm), electrons are photoexcited by irradiation with visible light or ultraviolet light having a wavelength of about 414 nm or less, and electron-hole pairs are generated. In a case of calcium titanium oxide, the band gap energy is about 3.4 eV (corresponding to a light wavelength of about 365 nm), electrons are photoexcited by irradiation with ultraviolet light having a wavelength of about 365 nm or less, and electron-hole pairs are generated. The light to be radiated needs to include light having a wavelength satisfying these conditions, and light not satisfying the conditions may be simultaneously irradiated.

The holes (h⁺) deprive electrons from water molecules (H₂O) (oxidation reaction), and generate oxygen (O₂) gas and protons (H⁺), as in a following chemical formula.

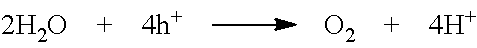

The excited electrons (e) in the conduction band react (reduction reaction) with the protons (H⁺) generated by the oxidation reaction to generate hydrogen (H₂) gas as in a following chemical formula.

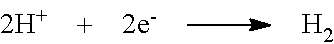

The cocatalyst 3 includes an oxidation cocatalyst 31 and a reduction cocatalyst 32, and traps each of holes and electrons on the photocatalyst 2 to promote the redox reaction. For example, when a high-performance cocatalyst such as rhodium (Rh) is used alone, not only decomposition reaction of water but also generation reaction is promoted, and there is a possibility that the decomposition reaction is stagnated. In view of such a problem, by supporting the oxidation cocatalyst 31 and the reduction cocatalyst 32 on the photocatalyst 2, both the oxidation reaction and the reduction reaction can be promoted, and an activity of the photocatalyst 2 can be improved.

A first cocatalyst 301 is supported on both the oxidation surface and the reduction surface of photocatalyst 2, and forms the oxidation cocatalyst 31 on the oxidation surface and forms the reduction cocatalyst 32 together with a second cocatalyst 302 on the reduction surface. The first cocatalyst 301 is a cocatalyst which assists in efficient consumption of holes on the oxidation surface and exhibits high cocatalytic activity by coexisting with the second cocatalyst 302 on the reduction surface. The first cocatalyst contains at least any of Group 3 to Group 7 elements, preferably contains a Group 5 or Group 6 element, and more preferably contains vanadium (V), molybdenum (Mo), or tungsten (W). Among them, molybdenum (Mo) is particularly preferable. In terms of a weight ratio with respect to the catalyst particle 1, content of any of the Group 3 to Group 7 elements is preferably 0.01 wt % or more, more preferably 0.1 wt % or more, and still more preferably 0.2 wt % or more. The oxidation cocatalyst 31 traps holes on the photocatalyst 2 to promote the oxidation reaction. The first cocatalyst 301 may contain, for example, vanadium oxide (V₂O₅), molybdenum oxide (MoOₓ) (x≤3), or tungsten oxide (WO₃). An element contained in the first cocatalyst 301 can take a plurality of oxidation states, and can exist in different oxidation states in the oxidation surface and the reduction surface. Examples of a material (precursor) of the first cocatalyst 31 include sodium molybdate (Na₂MoO₄), ammonium molybdate ((NH₄)₆Mo₇O₂₄·4H₂O), potassium molybdate (K₂MoO₄), molybdic acid (H₂MoO₄), sodium tungstate (Na₂WO₄), ammonium vanadate (Na3VO₄), and the like.

The Group 3 to Group 7 elements contained in the first cocatalyst 301 needs to be stably present in a group oxidation number, which is a highest oxidation number, and supported on the oxidation surface in order to exhibit an effect as the oxidation cocatalyst 31 which assists in efficient consumption of holes. In addition, the Group 3 to Group 7 elements contained in the first cocatalyst 301 needs to be stably present even in an oxidation number, which is lower than the highest oxidation number, and supported on the reduction surface in order to exhibit an effect as the highly efficient reduction cocatalyst 32 by coexisting with the second cocatalyst 302. Examples satisfying such conditions include a Group 6 element M which is stably present as a hexavalent oxide MO₃ on the oxidation surface and is present as a tetravalent oxide MO₂ on the reduction surface.

The second cocatalyst 302 becomes the reduction cocatalyst 32. The reduction cocatalyst 32 is a cocatalyst which traps electrons on the photocatalyst 2 to promote the reduction reaction, and preferably contains any of Group 8 to Group 11 elements, more preferably contains a Group 10 element, and still more preferably contains nickel (Ni). In terms of the weight ratio with respect to the catalyst particle 1, content of any of the Group 8 to Group 11 elements is preferably 0.01 wt % or more, and more preferably 0.1 wt % or more. The second cocatalyst 302 may include, for example, nickel oxide (NiOₓ) (x≤2), nickel phosphide (Ni₂P), or nickel sulfide (NiS, Ni₃S₂). Examples of a material (precursor) of the second cocatalyst 302 include, in addition to nickel nitrate (Ni(NO₃)₂), iron nitrate (Fe(NO₃)₃), copper nitrate (Cu(NO₃)₂), cobalt nitrate (Co(NO₃)₂), and the like.

The second cocatalyst 302 needs to be supported on the reduction surface and promote hydrogen generation by acting concertedly with the oxidation cocatalyst 31. In order to be supported on the reduction surface, the second cocatalyst 302 (second cocatalyst species) needs to be more easily reduced than the first cocatalyst 301 (first cocatalyst species). In transition metal, as a group number increases, electronegativity increases, and electrons are easily captured, that is, easily reduced. Therefore, the second cocatalyst has any of the Group 8 to Group 11 elements, preferably has the Group 10 element, and more preferably has Ni.

Particularly, when the first cocatalyst 301 contains any of the Group 3 to Group 7 elements and the second cocatalyst 302 contains any of the Group 8 to Group 11 elements, the activity of the photocatalyst can be remarkably improved compared to a combination of another oxidation cocatalyst and the reduction cocatalyst. Here, when the first cocatalyst 301 contains the Group 5 or Group 6 element, the activity is further improved, when the first cocatalyst 301 contains vanadium (V), molybdenum (Mo), or tungsten (W), the activity is more significantly improved, and when the first cocatalyst 301 contains molybdenum (Mo), the activity is even more significantly improved. In addition, the activity is improved when the second cocatalyst 302 contains the Group 10 element, and the activity is further improved when the second cocatalyst 302 contains nickel (Ni).

A weight ratio of the second cocatalyst 302 to the photocatalyst 2 is preferably greater than or equal to a weight ratio of the first cocatalyst 301 to the photocatalyst 2. When the weight ratio of the second cocatalyst 302 to the photocatalyst 2 is greater than or equal to the weight ratio of the first cocatalyst 301 to the photocatalyst 2, the redox reaction can be further promoted. The weight ratio of the second cocatalyst 302 to the photocatalyst 2 is preferably 2 times or more and more preferably 3 times or more, relative to the weight ratio of the first cocatalyst 301 to the photocatalyst 2.

The weight ratio of the first cocatalyst 301 to the photocatalyst 2 is not particularly limited, but is preferably 0.5 wt % or more and less than 3.0 wt %, and more preferably 0.5 to 2.0 wt %. When the weight ratio of the first cocatalyst 301 to the photocatalyst 2 is in such a range, the redox reaction can be further promoted.

The weight ratio of the second cocatalyst 302 to the photocatalyst 2 may be 0.5 wt % or more, preferably 1.0 wt % or more, more preferably 2.0 wt % or more, and still more preferably 3.0 wt % or more. When the weight ratio of the second cocatalyst 302 to the photocatalyst 2 is such a value, the redox reaction can be further promoted.

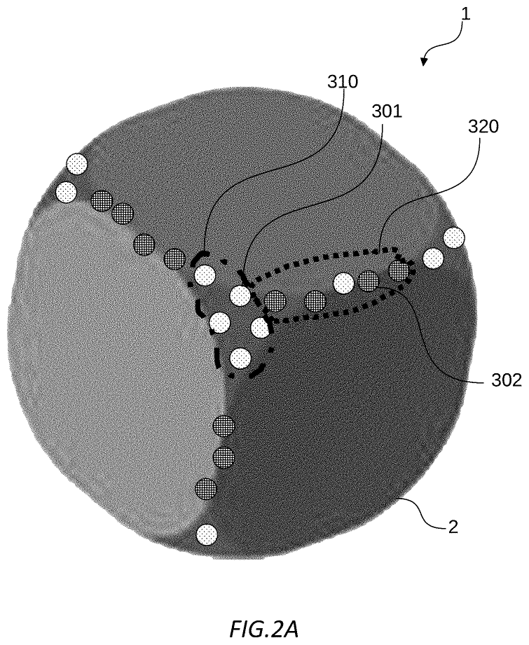

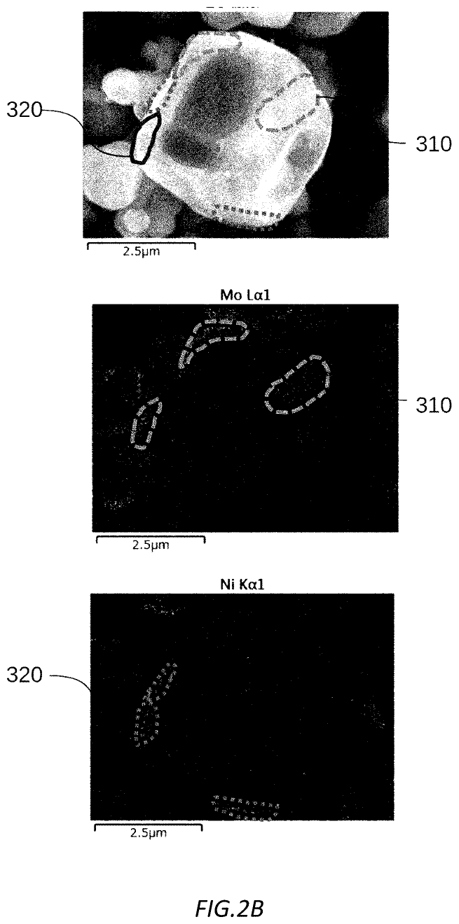

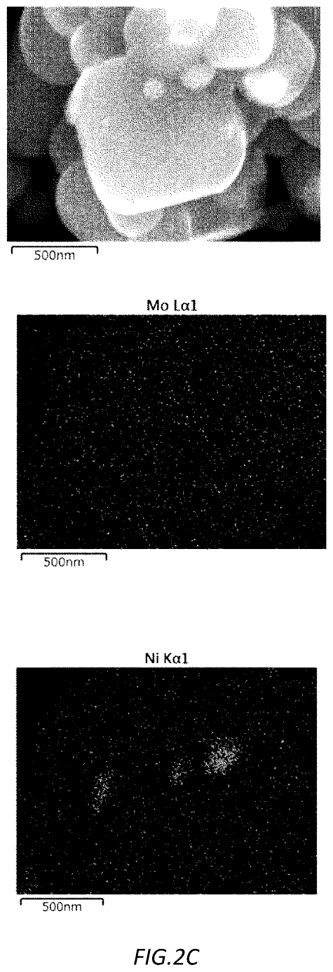

FIG. 2A schematically illustrates distributions of the first cocatalyst 301 and the second cocatalyst 302 on the photocatalyst 2. The photocatalyst 2 includes an oxidation surface 310 (indicated by an alternate long and short dash line) on which the first cocatalyst 301 is supported, and a reduction surface 320 (indicated by a dotted line) on which the first cocatalyst 301 and the second cocatalyst 302 are supported. As described above, it is preferable that a part of the first cocatalyst 301 and a part of the second cocatalyst 302 are respectively localized on specific facets of the photocatalyst 2. The first cocatalyst 301 as an oxidation cocatalyst and the first cocatalyst 301 and the second cocatalyst 302 as reduction cocatalysts are respectively localized on a facet serving as a specific oxidation surface of the photocatalyst 2 and a facet serving as a specific reduction surface of the photocatalyst 2, so that the redox reaction can be promoted.

In addition, it is preferable that a part of the first cocatalyst 301 and a part of the second cocatalyst 302 respectively localized on different facets of photocatalyst 2 overlap each other on the photocatalyst 2 to form the reduction surface 320. When a part of the first cocatalyst 301 and a part of the second cocatalyst 302 overlap each other on the photocatalyst 2, the first cocatalyst 301 and the second cocatalyst 302 can act concertedly to promote the redox reaction.

The catalyst particle 1 is produced by supporting the cocatalyst 3 on the photocatalyst 2 that is synthesized. As a method for supporting the cocatalyst 3 on the photocatalyst 2, a photodeposition method (SPD method) and an impregnation method (IMP method) in which both the first cocatalyst 301 and the second cocatalyst 302 are deposited, and a photodeposition method (PD method) in which the first cocatalyst 301 and the second cocatalyst 302 are deposited individually are known, and among them, the SPD method is preferable from a viewpoint of promoting the redox reaction. According to the SPD method, formation of an oxidation cocatalyst and a reduction cocatalyst on the oxidation surface 310 and the reduction surface 320 can be promoted.

FIG. 2B illustrates distributions on the photocatalyst 2 of the first cocatalyst 301 and the second cocatalyst 302 supported by the SPD method. A center is an energy dispersive X-ray spectroscopy (EDS) mapping image showing a distribution of Lα1 X-rays of molybdenum (Mo), a bottom is an EDS mapping image showing a distribution of Kα1 X-rays of nickel (Ni), and a top is an image in which distributions of molybdenum and nickel are superimposed on a scanning electron microscope image (SEM) of a catalyst particle. A region surrounded by a chain line is a region where molybdenum is deposited, and a region surrounded by a dotted line is a region where nickel is deposited. The region where molybdenum is deposited is the oxidation surface 310, and the region where nickel or both molybdenum and nickel are deposited is the reduction surface 320. According to these images, when supported by the SPD method, molybdenum and nickel are deposited on a facet of a catalyst particle, molybdenum is added to the oxidation surface 310 and the reduction surface 320, and nickel is added to the reduction surface 320. That is, molybdenum and nickel are present on the reduction surface 320 in an overlapping manner.

FIG. 2C illustrates distributions on the photocatalyst 2 of the first cocatalyst 301 and the second cocatalyst 302 supported by the PD method. A center is an EDS mapping image showing the distribution of Lα1 X-rays of molybdenum (Mo), a bottom is an EDS mapping image showing the distribution of Kα1 X-rays of nickel (Ni), and a top is an SEM image of a catalyst particle. According to these images, nickel supported by the PD method is segregated but not deposited on a specific facet of the catalyst particle, and molybdenum is uniformly deposited on a surface of the catalyst particle.

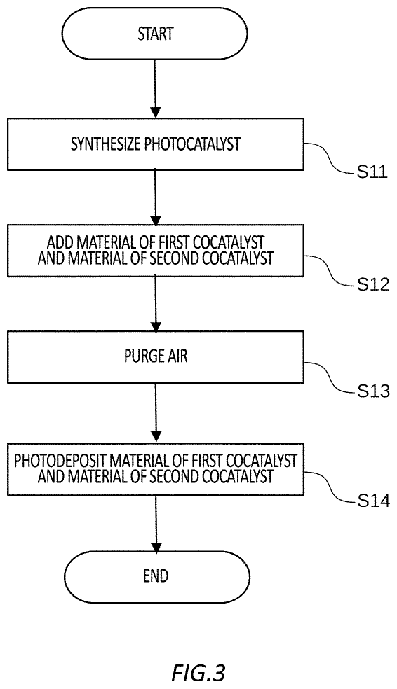

FIG. 3 illustrates a method for producing the catalyst particle 1 by supporting the cocatalyst 3 on the photocatalyst 2 by the SPD method.

In step S11, the photocatalyst 2 is synthesized by using a flux method or the like.

In step S12, an aqueous solution of a material of the first cocatalyst 301 and an aqueous solution of a material of the second cocatalyst 302 are added together to the photocatalyst 2 in a dark place.

In step S13, in the dark place, an inert gas represented by a rare gas is continuously supplied to the photocatalyst 2 to which the aqueous solution of the material of the first cocatalyst 301 and the aqueous solution of the material of the second cocatalyst 302 are added, and air (oxygen) is purged.

In step S14, in the dark place, ultraviolet light is radiated from a mercury (Hg) lamp or the like to excite the photocatalyst 2, the material of the first cocatalyst 301 is oxidized by holes and excited electrons generated by causing electrons in a valence band of the photocatalyst 2 to transition to a conduction band, the material of the second cocatalyst 302 is reduced, and both the oxidation cocatalyst 31 and the reduction cocatalyst 32 are photodeposited on a surface of the photocatalyst 2. By producing the catalyst particle 1 by such a method, formation of the oxidation surface 310 on which an oxidation cocatalyst exists on the photocatalyst 2 and the reduction surface 320 on which a reduction cocatalyst exists on the photocatalyst 2 can be promoted. Example 1

### Example 1

### (Synthesis of Photocatalyst)

Calcium carbonate (CaCO₃) and titanium oxide (TiO₂) were added and mixed in a 1:1 molar ratio in a double amount of ethanol. Further, sodium chloride (NaCl) was added as a flux, and a mixture was mixed for 5 minutes. The mixture was calcined at 1100° C. (temperature raising rate 200° C./h) for 10 hours. Thereafter, the mixture was cooled to 500° C. at 100° C./h to obtain calcium titanium oxide (CaTiO₃) as a photocatalyst. CaTiO₃ is hereinafter also referred to as CTO.

### (Support of Cocatalyst)

As described below, a cocatalyst was supported on CTO by the SPD method. First, in a dark place, sodium molybdate (Na₂MoO₄), which is the material of the first cocatalyst, at 1.0 wt % relative to CTO was added as an aqueous solution, and nickel nitrate (Ni(NO₃)₂) which is the material of the second cocatalyst was added as an aqueous solution such that nickel (Ni) was at 1.0 wt % relative to CTO. After addition, argon (Ar) gas was supplied at 30 mL/min for 1 hour in the dark place and purged with air (oxygen). After the purging, the cocatalyst was supported on the photocatalyst by irradiation with ultraviolet light for 3 hours using a mercury lamp (100 W), so as to obtain a catalyst particle.

### (Water Decomposition Test)

0.3 g of a catalyst particle was suspended in 0.36 L of water. In the dark place, a suspension was purged with air (oxygen) for 1 hour while argon gas was supplied at 30 mL/min. Components of a generated gas were analyzed by a gas chromatography-thermal conductivity detector (GC-TCD) while being irradiated with a mercury lamp (100 W).

### Example 2

A water decomposition test was performed in a manner similar to Example 1 except that sodium molybdate at 0.5 wt % relative to CTO was added.

### Example 3

A water decomposition test was performed in a manner similar to Example 1 except that sodium molybdate at 2.0 wt % relative to CTO was added.

### Example 4

A water decomposition test was performed in a manner similar to Example 1 except that sodium molybdate at 3.0 wt % relative to CTO was added.

### Example 5

A water decomposition test was performed in a manner similar to Example 1 except that nickel nitrate corresponding to nickel at 0.5 wt % relative to CTO was added.

### Example 6

A water decomposition test was performed in a manner similar to Example 1 except that nickel nitrate corresponding to nickel at 2.0 wt % relative to CTO was added.

### Example 7

A water decomposition test was performed in a manner similar to Example 1 except that nickel nitrate corresponding to nickel at 3.0 wt % relative to CTO was added.

### Example 8

A water decomposition test was performed in a manner similar to Example 1 except that nickel nitrate corresponding to nickel at 4.0 wt % relative to CTO was added.

### Example 9

A water decomposition test was performed in a manner similar to Example 1 except that sodium molybdate at 0.5 wt % relative to CTO and nickel nitrate corresponding to nickel at 3.0 wt % relative to CTO were added.

### Example 10

A water decomposition test was performed in a manner similar to Example 1 except that silver nitrate (AgNO₃) was added instead of nickel nitrate.

### Example 11

A water decomposition test was performed in a manner similar to Example 1 except that cobalt nitrate (Co(NO₃)₂) was added instead of nickel nitrate.

### Example 12

A water decomposition test was performed in a manner similar to Example 1 except that sodium tungstate (Na₂WO₄) at 1.0 wt % relative to CTO was added instead of sodium molybdate (Na₂MoO₄).

### Example 13

A water decomposition test was performed in a manner similar to Example 1 except that a cocatalyst was supported by using an impregnation method (IMP method), that is, nickel nitrate (Ni(NO₃)₂) at 3 wt % relative to CTO and sodium molybdate (Na₂MoO₄) at 1 wt % relative to CTO were added as an aqueous solution, then water was evaporated, and a mixture was calcined at 400° C. for 2 hours to obtain a catalyst particle.

### Example 14

A water decomposition test was performed in a manner similar to Example 1 except that a cocatalyst was supported by using an impregnation method (IMP method), that is, nickel nitrate (Ni(NO₃)₂) at 1 wt % relative to CTO and sodium molybdate (Na₂MoO₄) at 1 wt % relative to CTO were added as an aqueous solution, then water was evaporated, and a mixture was calcined at 500° C. for 2 hours to obtain a catalyst particle.

### Example 15

A water decomposition test was performed in a manner similar to Example 1 except that both the first cocatalyst and the second cocatalyst were not supported in a single supporting treatment, but a supporting treatment using nickel nitrate (Ni(NO₃)₂) was performed, and then a supporting treatment using sodium molybdate (Na₂MoO₄) was performed.

### Example 16

A water decomposition test was performed in a manner similar to Example 1 except that both the first cocatalyst and the second cocatalyst were not supported in a single supporting treatment, but a supporting treatment using sodium molybdate (Na₂MoO₄) was performed, and then a supporting treatment using nickel nitrate (Ni(NO₃)₂) was performed.

### Comparative Example 1

A water decomposition test was performed in a manner similar to Example 1 except that a cocatalyst was not supported.

### Comparative Example 2

A water decomposition test was performed in a manner similar to Example 1 except that nickel nitrate corresponding to nickel at 1.0 wt % relative to CTO was added instead of sodium molybdate (Na₂MoO₄) and that cobalt nitrate (Co(NO₃)₂) was added instead of nickel nitrate.

### Comparative Example 3

A water decomposition test was performed in a manner similar to Example 1 except that 0.003 g of a catalyst particle of molybdenum oxide (MoO₃) alone were used instead of CTO, and a cocatalyst was not supported on the catalyst particle. 0.003 g corresponds to an amount of the cocatalyst in Example 1.

### Comparative Example 4

A water decomposition test was performed in a manner similar to Example 1 except that 0.003 g of a catalyst particle of nickel oxide (NiO) alone were used instead of CTO, and a cocatalyst was not supported on the catalyst particle. 0.003 g corresponds to the amount of the cocatalyst in Example 1.

### Comparative Example 5

A water decomposition test was performed in a manner similar to Example 1 except that molybdenum oxide (MoO₃) was used instead of sodium molybdate (Na₂MoO₄), nickel oxide (NiO) was used instead of nickel nitrate (Ni(NO₃)₂), these and CTO were simply mixed, and a treatment of supporting a mixture on CTO was not performed.

### Comparative Example 6

A water decomposition test was performed in a manner similar to Example 1 except that sodium molybdate (Na₂MoO₄) was not used.

### Comparative Example 7

A water decomposition test was performed in a manner similar to Example 1 except that nickel nitrate (Ni(NO₃)₂) was not used.

### Comparative Example 8

A water decomposition test was performed in a manner similar to Example 1 except that rhodium (Rh) at 0.01 wt % relative to CTO was used as a cocatalyst.

### Comparative Example 9

A water decomposition test was performed in a manner similar to Example 1 except that platinum (Pt) at 0.01 wt % relative to CTO was used as a cocatalyst.

Results of the water decomposition tests of Examples 1 to 16 and Comparative Example 1 to 9 are shown in Table 1.

TABLE 1

| | | | | | | | GENERATION | |
|---|---|---|---|---|---|---|---|---|
| | | FIRST COCATALYST | | SECOND COCATALYST | | | AMOUNT | |
| | PHOTO- | | ADDED | | ADDED | SUPPORTING | (μmol/h) | |
| | CATALYST | TYPE | AMOUNT (wt %) | TYPE | AMOUNT (wt %) | METHOD | H₂ | O₂ |
| EXAMPLE 1 | CTO | Mo | 1 | Ni | 1 | SPD | 71 | 33 |
| EXAMPLE 2 | CTO | Mo | 0.5 | Ni | 1 | SPD | 67 | 31 |
| EXAMPLE 3 | CTO | Mo | 2 | Ni | 1 | SPD | 69 | 33 |
| EXAMPLE 4 | CTO | Mo | 3 | Ni | 1 | SPD | 54 | 25 |
| EXAMPLE 5 | CTO | Mo | 1 | Ni | 0.5 | SPD | 56 | 26 |
| EXAMPLE 6 | CTO | Mo | 1 | Ni | 2 | SPD | 108 | 50 |
| EXAMPLE 7 | CTO | Mo | 1 | Ni | 3 | SPD | 112 | 55 |
| EXAMPLE 8 | CTO | Mo | 1 | Ni | 4 | SPD | 110 | 53 |
| EXAMPLE 9 | CTO | Mo | 0.5 | Ni | 3 | SPD | 109 | 50 |
| EXAMPLE 10 | CTO | Mo | 1 | Ag | 1 | SPD | 6 | 3 |
| EXAMPLE 11 | CTO | Mo | 1 | Co | 1 | SPD | 7 | 4 |
| EXAMPLE 12 | CTO | W | 1 | Ni | 1 | SPD | 24 | 11 |
| EXAMPLE 13 | CTO | Mo | 1 | Ni | 3 | IMP (400° C.) | 27 | 13 |
| EXAMPLE 14 | CTO | Mo | 1 | Ni | 1 | IMP (500° C.) | 7 | 3 |
| EXAMPLE 15 | CTO | Ni | 1 | Mo | 1 | INDIVIDUALLY PD | 22 | 10 |
| EXAMPLE 16 | CTO | Mo | 1 | Ni | 1 | INDIVIDUALLY PD | 20 | 9 |
| COMPARATIVE | CTO | — | — | — | — | — | <1 | <1 |
| EXAMPLE 1 | | | | | | | | |
| COMPARATIVE | CTO | Co | 1 | Ni | 1 | SPD | 5 | 3 |
| EXAMPLE 2 | | | | | | | | |
| COMPARATIVE | MoO₃ | — | — | — | — | — | 1 | <1 |
| EXAMPLE 3 | | | | | | | | |
| COMPARATIVE | NiO | — | — | — | — | — | 5 | 2 |
| EXAMPLE 4 | | | | | | | | |
| COMPARATIVE | CTO, | — | — | — | — | MIX | 1 | 1 |
| EXAMPLE 5 | MoO₃, | | | | | | | |
| | NiO | | | | | | | |
| COMPARATIVE | CTO | — | — | Ni | 1 | PD | 4 | 30 |
| EXAMPLE 6 | | | | | | | | |
| COMPARATIVE | CTO | — | — | Mo | 1 | PD | 2 | 2 |
| EXAMPLE 7 | | | | | | | | |
| COMPARATIVE | CTO | — | — | Rh | 0.01 | PD | 29 | 13 |
| EXAMPLE 8 | | | | | | | | |
| COMPARATIVE | CTO | — | — | Pt | 0.01 | IMP | 34 | 15 |
| EXAMPLE 9 | | | | | | | | |

### (Examination of Effect of Supporting)

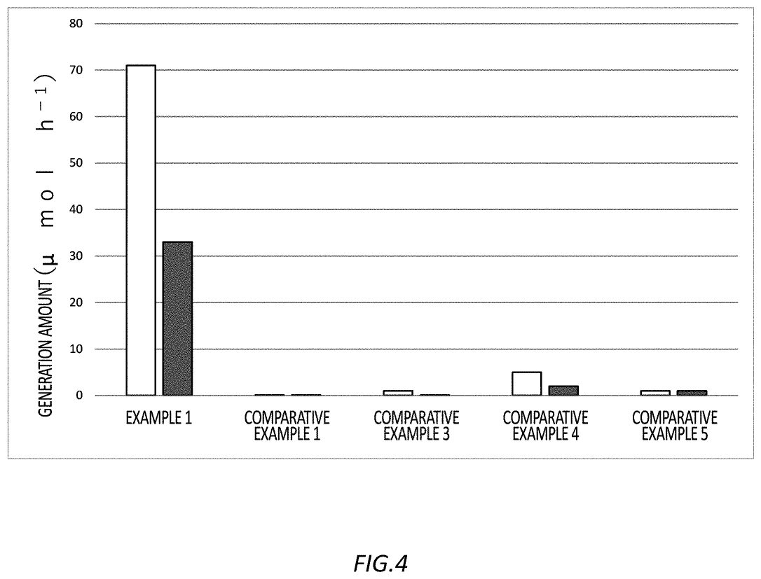

FIG. 4 illustrates the results of water decomposition tests using a catalyst particle in which molybdenum and nickel were supported on CTO (Example 1), a catalyst particle consisting of CTO alone (Comparative Example 1), a catalyst particle consisting of molybdenum oxide (MoO₃) alone (Comparative Example 3), a catalyst particle consisting of nickel oxide (NIO) alone (Comparative Example 4), and a catalyst particle in which NiO and MoO₃ were simply mixed with CTO (Comparative Example 5). A vertical axis represents an amount of substance generated per hour (μmol h⁻¹). In each example, a left bar indicates a hydrogen generation amount, and a right bar indicates an oxygen generation amount. The hydrogen generation amount is about 2 times the oxygen generation amount. It can be seen that an activity of Example 1, which is a catalyst particle in which any of the Group 3 to Group 7 elements and any of the Group 8 to Group 11 elements are supported on the photocatalyst, is 10 times or more other examples.

An activity of Comparative Example 1, which is a catalyst particle of CTO alone, is the lowest, and as compared with this, in Example 1, performance of CTO as a photocatalyst is remarkably improved by a cocatalyst. Activities of Comparative Examples 3 and 4 respectively using, as catalyst particles, MoO₃ alone and NiO alone in an amount corresponding to the cocatalyst of Example 1 were slight relative to the activity of Example 1. An activity of Comparative Example 5 in which NiO and MoO₃ are simply mixed with CTO is lower than that of Comparative Example 10 using NiO alone. This decrease is considered to be due to a fact that irradiation light is blocked by CTO and a photocatalytic activity of an NiO carrier is suppressed. As can be seen from the above, any of the Group 3 to Group 7 elements and any of the Group 8 to Group 11 elements exhibit a high activity by being supported on CTO as a cocatalyst.

### (Examination of Combination of Cocatalysts)

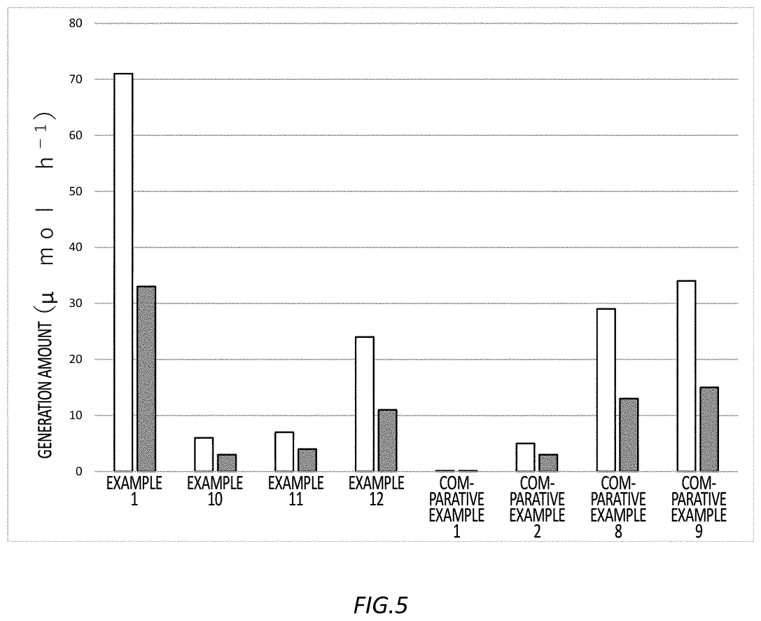

FIG. 5 illustrates the results of water decomposition tests using a catalyst particle (Examples 1 and 10 to 12, and Comparative Example 2) in which two types of cocatalysts were supported on a photocatalyst by the SPD method, a catalyst particle consisting of CTO alone (Comparative Example 1), and a catalyst particle (Comparative Examples 8 and 9) in which a noble metal was supported as a cocatalyst on a photocatalyst. A vertical axis represents an amount of substance generated per hour (μmol h⁻¹), a left bar of each example represents a hydrogen generation amount, and a right bar represents an oxygen generation amount. Examples 1 and 10 to 12, which were catalyst particles in which any of the Group 3 to Group 7 elements and any of the Group 8 to Group 11 elements were supported on a photocatalyst, not only exhibited remarkably higher water decomposability than that of Comparative Example 1, which was a catalyst particle of CTO alone, but was also superior in the hydrogen generation amount compared to Comparative Example 2 in which two types of cocatalysts were supported but none of the Group 3 to Group 7 elements were included. In addition, among Examples 1 and 10 to 12, particularly Example 1 containing molybdenum as the first cocatalyst and containing nickel as the second cocatalyst exhibited a uniquely high activity of 10 times or more in comparison with Comparative Example 2. Further, Example 1 exhibited a high activity of 2 times even in comparison with Comparative Examples 8 and 9 having a noble metal cocatalyst known to be expensive but high in performance. In addition, Example 12 containing a Group 6 element and a Group 10 element also exhibited an excellent activity comparable to that of the noble metal cocatalyst. From the above, when any of the Group 3 to Group 7 elements is contained as the first cocatalyst and the Group 8 to Group 11 elements are contained as the second cocatalyst, the activity of the photocatalyst can be improved compared to a combination of another oxidation cocatalyst and the reduction cocatalyst. A combination of the Group 6 element and the Group 10 element remarkably improves the activity, and particularly, a combination of molybdenum and nickel can dramatically improve the activity.

### (Examination of Effect of Supporting First Cocatalyst and Second Cocatalyst)

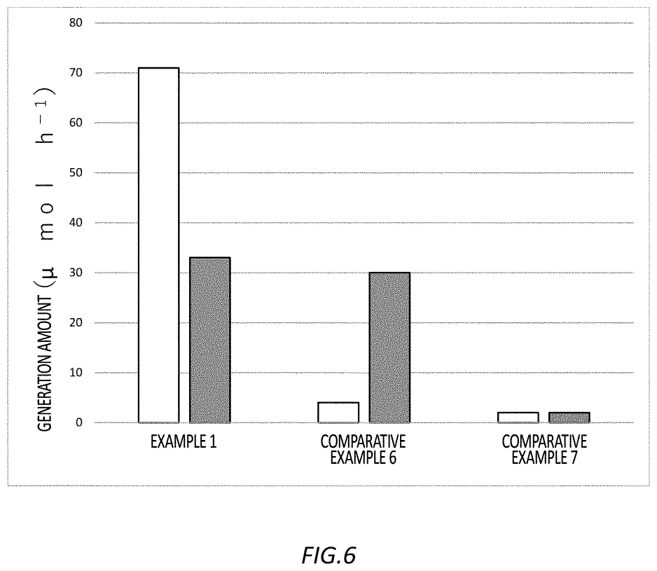

FIG. 6 illustrates results of water decomposition tests using a catalyst particle using nickel nitrate and sodium molybdate as cocatalyst materials (Example 1), a catalyst particle using nickel nitrate alone as a cocatalyst material (Comparative Example 6), and a catalyst particle using sodium molybdate alone as a cocatalyst material (Comparative Example 7). A vertical axis represents an amount of substance generated per hour (μmol h⁻¹), a left bar of each example represents a hydrogen generation amount, and a right bar represents an oxygen generation amount. A hydrogen generation capability of Example 1 using nickel nitrate and sodium molybdate as cocatalyst materials was 15 times or more larger than those of Comparative Example 6 using nickel nitrate alone as a cocatalyst material and Comparative Example 7 using sodium molybdate alone as a cocatalyst material, and even a combined generation amount of hydrogen of Comparative Examples 6 and 7 did not reach the hydrogen generation amount of Example 1 at all. Thus, when both nickel and molybdenum are contained in a cocatalyst, the activity of the photocatalyst can be remarkably improved compared to a catalyst particle containing only nickel or only molybdenum as the cocatalyst.

### (Examination of Supporting Method)

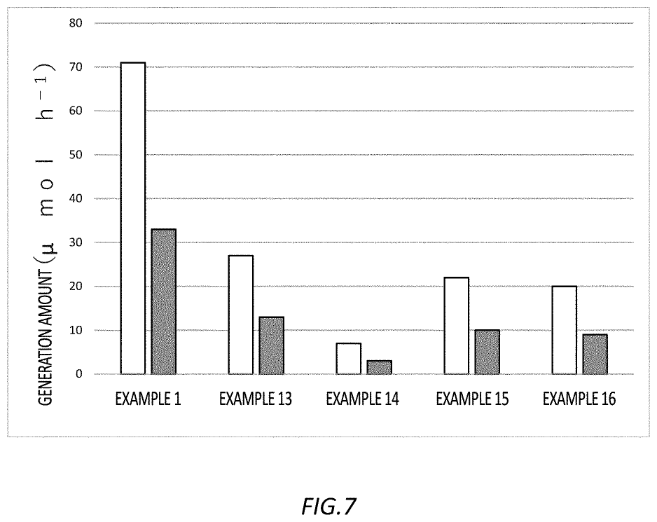

FIG. 7 illustrates results of water decomposition tests using different catalyst particles (Example 1, Examples 13 to 16) in a method for supporting the first cocatalyst and the second cocatalyst on a photocatalyst. A vertical axis represents an amount of substance generated per hour (μmol h⁻¹), a left bar of each example represents a hydrogen generation amount, and a right bar represents an oxygen generation amount. Example 1 in which both a molybdenum compound and a nickel compound were supported by the SPD method exhibited a high activity of about 3 times as compared with Examples 13 and 14 in which a molybdenum compound and a nickel compound were supported by the IMP method and Examples 15 and 16 in which a molybdenum compound and a nickel compound were sequentially supported by the PD method. From the above, the activity of the photocatalyst can be further improved by a method in which both the first cocatalyst and the second cocatalyst are supported by the SPD method.

### (Examination of Loading Amount of First Cocatalyst)

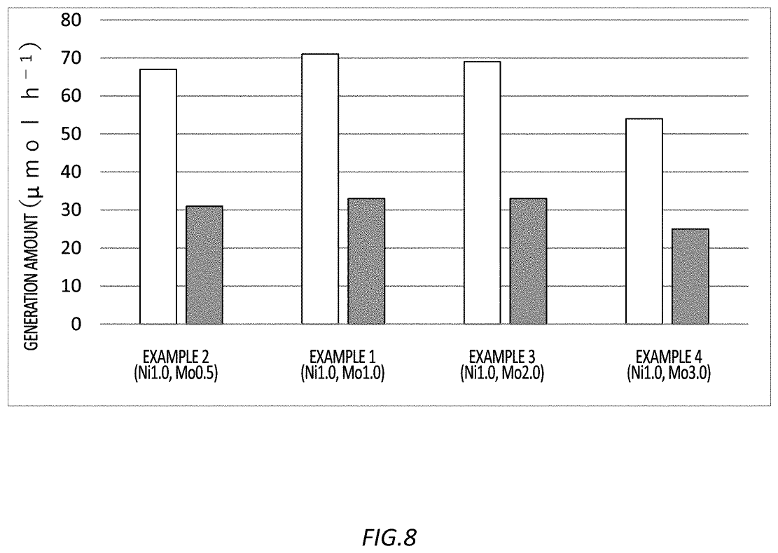

FIG. 8 illustrates results of water decomposition tests using a catalyst particle (Examples 2, 1, 3, and 4) in which a loading amount of the first cocatalyst was varied. A vertical axis represents an amount of substance generated per hour (μmol h⁻¹), a left bar of each example represents a hydrogen generation amount, and a right bar represents an oxygen generation amount. It can be seen that the generation amounts of hydrogen and oxygen in Examples 2, 1, 3, and 4 do not greatly vary, and the loading amount of Mo as the first cocatalyst does not significantly affect the activity of the catalyst particle. In Example 4, the generation amounts of hydrogen and oxygen are slightly reduced, and thus the loading amount of the first cocatalyst is preferably 0.5 wt % or more and less than 3.0 wt %, and more preferably 0.5 wt % or more and 2.0 wt % or less relative to the amount of the photocatalyst 2.

### (Examination of Loading Amount of Second Cocatalyst)

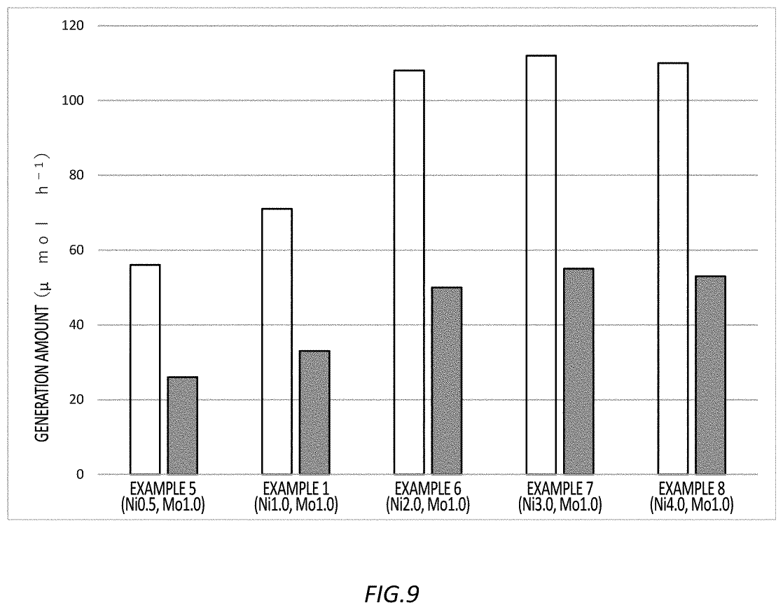

FIG. 9 illustrates results of water decomposition tests using a catalyst particle (Examples 5, 1, 6, 7, and 8) in which a loading amount of the second cocatalyst was varied. A vertical axis represents an amount of substance generated per hour (μmol h⁻¹), a left bar of each example represents a hydrogen generation amount, and a right bar represents an oxygen generation amount. From Examples 5, 1, 6, 7, and 8, it can be seen that an increase in the loading amount of Ni as the second cocatalyst significantly affects the activity of the catalyst particle. Activation due to the increase in Ni is particularly remarkable in Example 6 and is maximal in Example 7, and a difference between Examples 7 and 8 is slight. Therefore, the loading amount of the second cocatalyst may be 0.5 wt % or more, preferably 1.0 wt % or more, more preferably 2.0 wt % or more, and still more preferably 3.0 wt % or less relative to the amount of the photocatalyst 2.

### (Examination of Composition Ratio of First Cocatalyst and Second Cocatalyst)

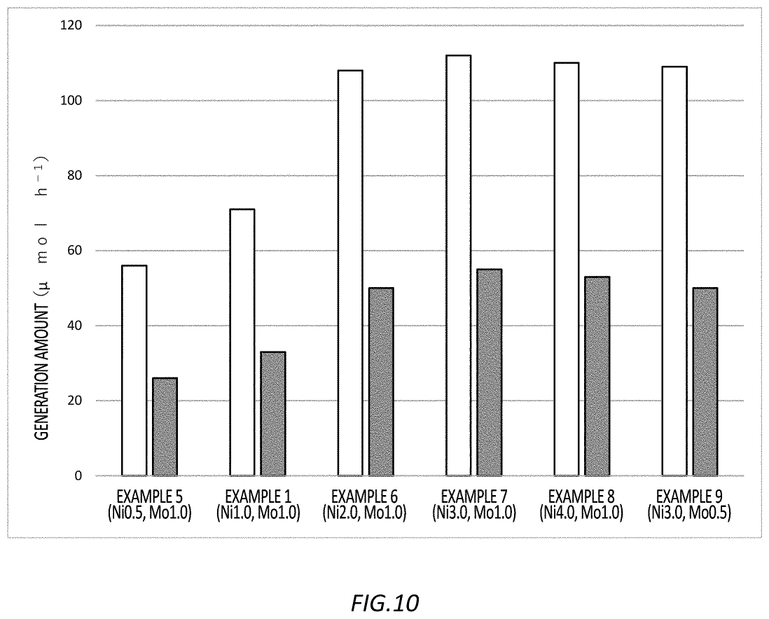

FIG. 10 illustrates results of water decomposition tests using a catalyst particle (Examples 5, 1, 6, 7, 8, and 9) in which a composition ratio of the first cocatalyst and the second cocatalyst was varied. A vertical axis represents an amount of substance generated per hour (μmol h⁻¹), a left bar of each example represents a hydrogen generation amount, and a right bar represents an oxygen generation amount. From comparison of Example 5 with Examples 1, 6, 7, 8, and 9, it can be seen that when a weight ratio of Ni as the second cocatalyst to the photocatalyst is greater than or equal to a weight ratio of Mo as the first cocatalyst to the photocatalyst, the generation amounts of hydrogen and oxygen further increase. Activation is remarkable in Example 6 and is maximal in Example 7, and a difference between Examples 7 to 9 is slight. Therefore, the weight ratio of the first cocatalyst to the photocatalyst 2 is preferably 2 times or more and more preferably 3 times or more, relative to the weight ratio of the first cocatalyst to the photocatalyst 2.

While the present invention has been described by way of the embodiments, the technical scope of the present invention is not limited to the above-described embodiments. It is apparent to persons skilled in the art that various alterations or improvements can be made to the above described embodiments. It is also apparent from description of the claims that the embodiments to which such modifications or improvements are made may be included in the technical scope of the present invention.

It should be noted that each process of the operations, procedures, steps, stages, and the like performed by the apparatus, system, program, and method shown in the claims, specification, or drawings can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

1: catalyst particle; 2: photocatalyst; 3: cocatalyst; 31: oxidation cocatalyst; 32: reduction cocatalyst; 301: first cocatalyst; 302: second cocatalyst; 310: oxidation surface; and 320: reduction surface.

What is claimed is:

1. A catalyst particle which decomposes water molecules upon irradiation with light to generate hydrogen and oxygen, wherein
the catalyst particle comprises a photocatalyst and a cocatalyst which is supported on the photocatalyst,
the cocatalyst contains a first cocatalyst and a second cocatalyst, and
the first cocatalyst contains at least one of Group 3 to Group 7 elements.

2. The catalyst particle according to claim 1, wherein the first cocatalyst particularly contains a Group 5 or Group 6 element.

3. The catalyst particle according to claim 1, wherein the first cocatalyst particularly contains vanadium (V), molybdenum (Mo), or tungsten (W).

4. The catalyst particle according to claim 1, wherein the first cocatalyst particularly contains molybdenum (Mo).

5. The catalyst particle according to claim 1, wherein the second cocatalyst contains at least one of Group 8 to Group 11 elements.

6. The catalyst particle according to claim 1, wherein the second cocatalyst particularly contains a Group 10 element.

7. The catalyst particle according to claim 1, wherein the second cocatalyst particularly contains Ni.

8. The catalyst particle according to claim 1, wherein the photocatalyst contains titanium in an amount of 16 at % or more.

9. The catalyst particle according to claim 8, wherein the photocatalyst is a titanate.

10. The catalyst particle according to claim 8, wherein the photocatalyst has a perovskite-type crystal structure.

11. The catalyst particle according to claim 1, wherein a weight ratio of the second cocatalyst to the photocatalyst is greater than or equal to a weight ratio of the first cocatalyst to the photocatalyst.

12. The catalyst particle according to claim 1, wherein a part of the first cocatalyst and a part of the second cocatalyst are respectively localized on different facets of the photocatalyst.

13. The catalyst particle according to claim 12, wherein a part of the first cocatalyst and a part of the second cocatalyst overlap each other on the photocatalyst.

14. A method for producing the catalyst particle according to claim 1, comprising
supporting the first cocatalyst and the second cocatalyst on the photocatalyst, wherein
the supporting includes any one of supporting both the first cocatalyst and the second cocatalyst on the photocatalyst by a photodeposition method, supporting both the first cocatalyst and the second cocatalyst on the photocatalyst by an impregnation method, or supporting the first cocatalyst and the second cocatalyst individually on the photocatalyst by a photodeposition method.

15. A method for producing the catalyst particle according to claim 2, comprising
supporting the first cocatalyst and the second cocatalyst on the photocatalyst, wherein
the supporting includes any one of supporting both the first cocatalyst and the second cocatalyst on the photocatalyst by a photodeposition method, supporting both the first cocatalyst and the second cocatalyst on the photocatalyst by an impregnation method, or supporting the first cocatalyst and the second cocatalyst individually on the photocatalyst by a photodeposition method.

16. A method for producing the catalyst particle according to claim 5, comprising
supporting the first cocatalyst and the second cocatalyst on the photocatalyst, wherein
the supporting includes any one of supporting both the first cocatalyst and the second cocatalyst on the photocatalyst by a photodeposition method, supporting both the first cocatalyst and the second cocatalyst on the photocatalyst by an impregnation method, or supporting the first cocatalyst and the second cocatalyst individually on the photocatalyst by a photodeposition method.

17. A method for producing the catalyst particle according to claim 8, comprising
supporting the first cocatalyst and the second cocatalyst on the photocatalyst, wherein
the supporting includes any one of supporting both the first cocatalyst and the second cocatalyst on the photocatalyst by a photodeposition method, supporting both the first cocatalyst and the second cocatalyst on the photocatalyst by an impregnation method, or supporting the first cocatalyst and the second cocatalyst individually on the photocatalyst by a photodeposition method.

18. A method for producing the catalyst particle according to claim 11, comprising
supporting the first cocatalyst and the second cocatalyst on the photocatalyst, wherein
the supporting includes any one of supporting both the first cocatalyst and the second cocatalyst on the photocatalyst by a photodeposition method, supporting both the first cocatalyst and the second cocatalyst on the photocatalyst by an impregnation method, or supporting the first cocatalyst and the second cocatalyst individually on the photocatalyst by a photodeposition method.

19. A method for producing the catalyst particle according to claim 12, comprising
supporting the first cocatalyst and the second cocatalyst on the photocatalyst, wherein
the supporting includes any one of supporting both the first cocatalyst and the second cocatalyst on the photocatalyst by a photodeposition method, supporting both the first cocatalyst and the second cocatalyst on the photocatalyst by an impregnation method, or supporting the first cocatalyst and the second cocatalyst individually on the photocatalyst by a photodeposition method.

20. The method for producing the catalyst particle according to claim 14, wherein the supporting includes supporting both the first cocatalyst and the second cocatalyst on the photocatalyst by a photodeposition method.
